(19) United States
(12) Patent Application Publication
(10) Pub. No.: US 2008/0190139 A1
(43) Pub. Date: Aug. 14, 2008

(54) Precious, Semiprecious or Mineral Cut Stone, and the Method of Cutting Same

(76) Inventors: Takehiko Sato, Antwerp (BE); Misuzu Koganei, Kanagawaken (JP); Hiroyuki Koganei, Kanagawaken (JP)

Correspondence Address: SUGHRUE MION, PLLC, 2100 PENNSYLVANIA AVENUE, N.W., SUITE 800, WASHINGTON, DC, 20037, US

(21) Appl. No.: 11/915,158

(22) PCT Filed: May 19, 2006
(86) PCT No.: PCT/BE2006/000055

§ 371 Date: Mar. 20, 2008

(30) Foreign Application Priority Data
May 25, 2005 (EP) 2005/0259

(51) Int. Cl. A44C 17/00; B28D 5/00

(52) U.S. Cl. 63/32; 125/30.01

(57) ABSTRACT

The invention concerns a precious, semi-precious or mineral cut stone, comprising a crown (1) including in its center a planar table (2) surrounded with several facets of the crown (3-5), a pavilion (6) comprising a pointed culet (8) and several pavilion facets (9-12 and 17), and between the crown (1) and the pavilion (6), a girdle (7). The invention is characterized in that said pavilion facets comprise at least one top facet (9-12) extending between said pointed culet (8) and an intermediate location (13-16) between the girdle (7) and the culet (8).

The present invention relates to a precious, semiprecious or mineral cut stone, comprising
a crown comprising at its centre a planar table surrounded by several crown facets,
a pavilion comprising a pointed culet and several pavilion facets, and
between the crown and the pavilion, a girdle.

Such cut stones are well known. Reference can for example be made to diamonds, in particular those with a brilliant cut, in particular according to the cut called Round Brilliant Cut.

Stone observation devices are also known, which make it possible to view an image by reflection of light through the diamond under particular lighting conditions (see for example JP 6174648).

When a diamond is observed in such a device on the crown side upwards, the phenomenon called “arrow” can be observed, that is to say a reflected deformed projection of the arrangement of pavilion facets is observed. In a diamond treated according to a Round Brilliant Cut, eight “arrows” will be observed. If the number of pavilion facets is increased, it will be possible to observe ten “arrows” (see for example JP 2004299370). This type of modification in cut does not however prevent a deformation of the image projected through the crown after reflection of light on the pavilion facets of the diamond.

The aim of the present invention is to develop a cut stone not having this drawback and therefore allowing observation of an undeformed image in an observation device according to the aforementioned prior art. Advantageously, the stone thus cut will have improved brilliance and, according to its size, will allow the projection of sharp, different and original images.

To resolve these problems, a cut stone as indicated at the start has been provided, in which the said pavilion facets comprise at least one point facet that extends between the said pointed culet and an intermediate location between the girdle and the culet. Preferably the said point facet extends from the said pointed culet as far as the said intermediate location. The point facets therefore do not extend as far as the girdle. It consequently becomes possible to arrange them so as to be able to observe their image in the observation device according to the aforementioned prior art without deformation since it can no longer be reflected through the facets of the crown, as is the case currently with diamonds cut in the usual way.

It thus becomes possible to confer on the stone an image representing a form or a symbol selected by the size of the point facets. The stones in a production can consequently be characterised by attributing to them an original symbol corresponding for example to a quality or origin label in a way that is not visible during the normal use of the stone, that is to say for example in the form of a mounted jewel.

According to an improved embodiment of the invention, a point facet is, with respect to the said culet, situated opposite each aforementioned point facet, so that light projected through the said crown at a predetermined angle with respect to the table undergoes a first reflection on a point facet with projection of an image thereof towards the said point facet opposite where the light undergoes a second reflection with projection of the said image through the crown, and the said intermediate location of each point facet is disposed between the girdle and the culet in such a way that the image of each point facet issuing from the said second reflection is totally projected perpendicularly through the planar table of the crown. In this arrangement, the reflected image of the point facets of the pavilion is projected through the table of the crown, which is entirely planar and perpendicular to the reflected rays, which therefore causes no optical deformation.

According to an advantageous embodiment of the invention, the said at least one point facet extends at an angle 25° to 52°, preferably 36° to 41°, with respect to the table. For example, when the light passing through the observation device according to the aforementioned known prior art is projected at an aforementioned predetermined angle of around 98° with respect to the table, the crown facets are disposed at an angle of 25° to 80°, preferably 33° to 37°, with respect to the table and the said point facets lie at an angle of 40° to 41° with respect to the table.

Under these conditions, the reflection of incident light is at a maximum, which appreciably improves the brilliance of the stone.

The present invention also concerns a stone cutting method comprising a faceting of a crown having at its centre a planar table surrounding by crown facets, a faceting of a pavilion having a pointed culet and several pavilion facets and a formation of a girdle between the crown and the pavilion. This method is characterised in that it comprises a cutting of at least one pavilion facet in the form of a point facet that extends from the pointed culet to an intermediate location between the girdle and the culet.

Other embodiments of the cut stone according to the invention and its cutting method are indicated in the accompanying claims.

Other details and particularities of the invention will emerge from the description of cut stones, given below non-limitatively and with reference to the accompanying drawings.

FIG. 1 shows a plan view from above of the crown of a diamond according to the invention.

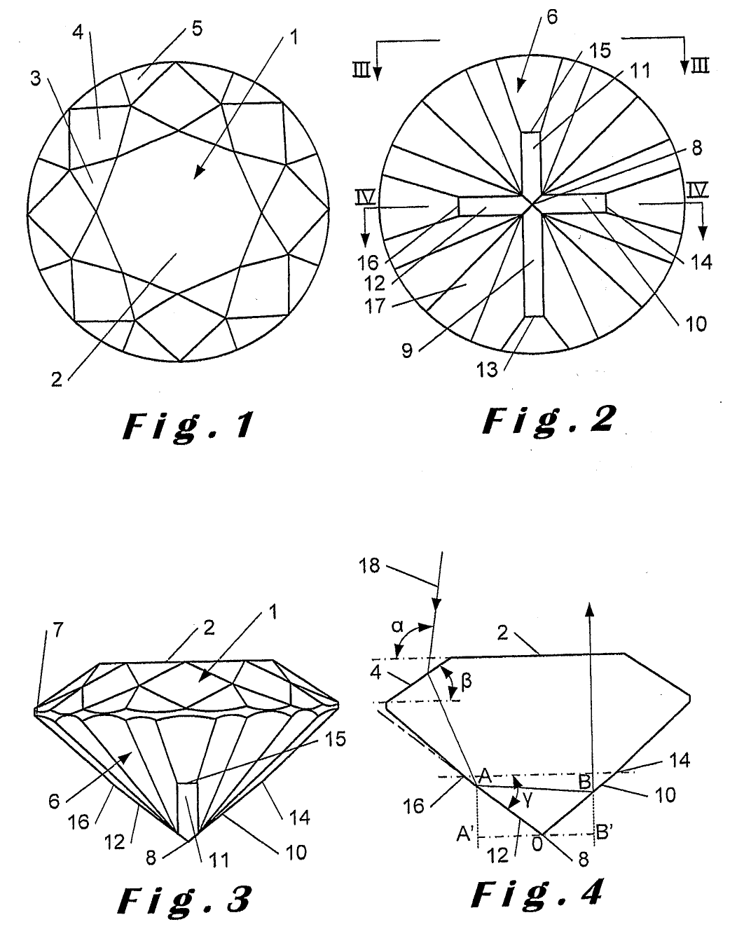

FIG. 2 shows a plan view from below of the pavilion of the diamond of FIG. 1.

FIG. 3 shows a side view of the diamond of FIG. 2, in the direction of the arrows III-III.

FIG. 4 shows a view in section, along the line IV-IV, of the diamond of FIG. 2.

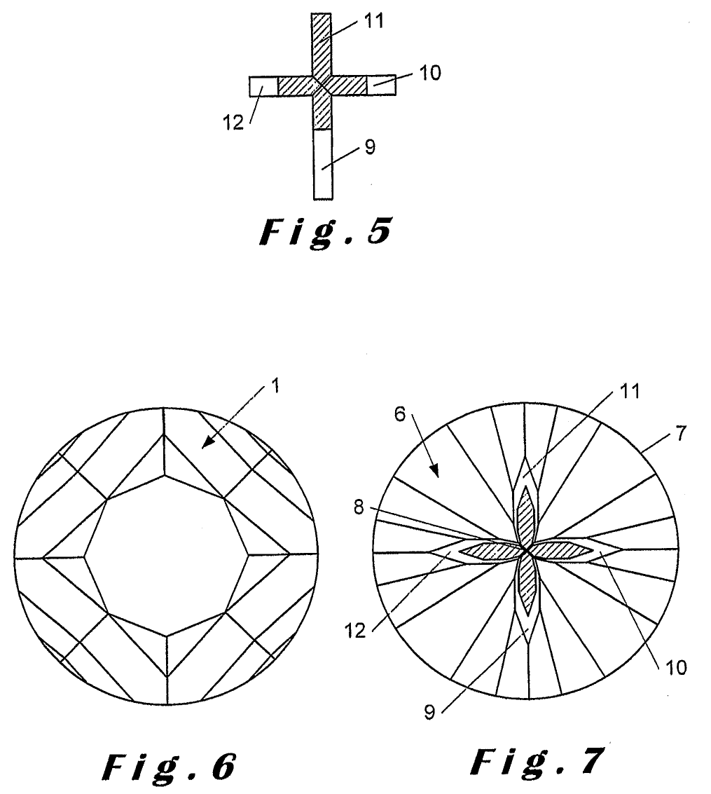

FIG. 5 shows a view of the point facets of the pavilion of the diamond shown in FIGS. 1 to 3.

FIGS. 6 and 7 are views, similar to FIGS. 1 and 2, of another diamond according to the invention.

In the various figures, the identical or similar elements are designated by the same reference numbers.

The description that follows relates to cut diamonds. It must be understood that the present invention also concerns other cut stones, for example rubies, emeralds, etc.

As is clear from FIG. 1, the diamond illustrated has a crown 1 comprising at its centre a planar table 2 surrounded by several crown facets. These crown facets, in the usual manner, consist of eight star facets 3, eight bezels 4 and sixteen crown corner facets 5.

FIG. 2 illustrates the pavilion 6. As is clear from FIG. 3, this is separated from the crown 1 by a girdle 7 or outer edge and terminates at the tip in a pointed culet 8.

Among the facets of the pavilion 6, there are four facets which, in the present document, are called point facets 9, 10, 11 and 12. These facets extend between the pointed culet 8, in this particular case from the culet itself, as far as a location 13, 14, 15 and 16 that is intermediate between the culet 8 and the girdle 7. In other words, these point facets do not extend as far as the girdle, as is the case with the culet facets of diamonds cut in the usual way. The other facets of the pavilion will be called the pavilion corner facets 17. It can also be noted that, in the example illustrated, the point facet 9 is longer than the other point facets 10 to 12 and that together they form a cross with asymmetric arms. Finally, it can also be remarked that, for each point facet, a point facet situated opposite with respect to the culet has been cut.

In FIG. 4, the diamond is disposed with the crown upwards and the table is in the horizontal position. It is in fact installed in an observation device according to the aforementioned prior art and receives incident light, the rays 18 of which have in this example an angle α of approximately 98° with respect to the horizontal, that is to say with respect to the plane of the table 2. This light passes through a bezel 4, while being slightly diverted. The bezel has, with respect to the horizontal, for example an angle β of between 25° and 80°, in particular from 33° to 37°.

In this example illustrated in FIG. 4, the point facets 10 and 12 have been cut so as to have, with respect to the horizontal, an angle γ of between 25° and 52°, advantageously between 36° and 41°, preferably between 40° and 41°.

It should be noted that the angles are to be adapted according to the typical refractive indices of the various stones.

As is illustrated in FIG. 5, the light ray 18 diverted by the bezel 4 is reflected on the point facet 12 in the direction of the opposite point facet 10, where it is reflected once again, vertically, with projection through the table 2 of the crown, that is to say perpendicular thereto. The intermediate location 16 of the point facet 12 has therefore been chosen so that an incident ray that strikes it is also, after double reflection, projected through the table 2. In this way a projection of the image of any part of the point facets through the crown facets is prevented and a certain loss of brilliance is avoided. The image observable in the observation device is sharp, without an optical deformation of the “arrow” type.

At the culet is the centre of the diamond, which is designated by the reference O in FIG. 4. The location of the first reflection of the incident ray on the point facet 12 is designated by the reference A. The projection of A on a horizontal plane passing through O gives a point A′. The location of the second reflection of the light ray on the opposite point facet 10 is designated by the reference B and the projection thereof on the horizontal plane passing through O is designated by the reference B′. As can be seen in FIG. 4, the distance OA′ is greater than the distance OB′, which means that the image viewed in the observation device is smaller than reality.

FIG. 5 illustrates solely the point facets 9 to 12 in a view from below. The hatched area shows the image that can be seen when looking at the diamond from above in the observation device. It will be noted that the image is inverted. The lengths of the point facets 9 and 11 have been measured so that a total reflection of the largest point facet 9 is possible on the point facet 10, although it has a smaller size. This proves possible given the reduction in the dimensions of the image during the reflections, as explained above.

FIGS. 6 and 7 show a variant embodiment of a cut stone according to the invention in which the facets, both crown and pavilion, have received different shapes from those obtained in the stone according to FIGS. 1 and 2.

The point facets 9 to 12 extend here also between the culet 8 and an intermediate location between the culet and the girdle 7. They are disposed symmetrically with respect to the culet and extend over the same length, each having the shape of an elongate irregular hexagon.

FIG. 7 shows, in a hatched area, as in FIG. 5, the image that could be observed by disposing this stone, with the crown upwards, in an observation device according to the aforementioned prior art.

It must be understood that the present invention is in no way limited to the embodiments described above and that many modifications could be made thereto without departing from the scope of the following claims.

It would be possible for example to imagine point facets having other forms and disposed not only in a cross but also for example in a bow or so as to form a polygon around the pointed culet.

1. Precious, semi-precious or mineral cut stone, comprising
a crown (1) comprising at its centre a planar table (2) surrounded by several crown facets (3-5),
a pavilion (6) comprising a pointed culet (8) and several pavilion facets (9-12 and 17), and
between the crown (1) and the pavilion (6), a girdle (7),
characterised in that the said pavilion facets comprise at least one point facet (9-12) that extends between the said pointed culet (8) and an intermediate location (13-16) between the girdle (7) and the culet (8).

2. Stone according to claim 1, characterised in that a point facet (9-12) is, with respect to the said culet (8), situated opposite each aforementioned point facet, so that light (18) projected through the said crown (1) at a predetermined angle (α) with respect to a perpendicular to the table (2) undergoes a first reflection on a point facet (12) with projection of an image thereof towards the said opposite point facet (10) where the light undergoes a second reflection with projection of the said image through the crown, and in that the said intermediate location (13-16) of each point facet is disposed between the girdle (7) and the culet (8) so that the image of each point facet issuing from the said second reflection is totally projected through the planar table (2) of the crown.

3. Stone according to claim 1, characterised in that the said at least one point facet (9-12) extends at an angle of 25° to 52° with respect to the table (2).

4. Stone according to claim 2, characterised in that crown facets are disposed at an angle of 25° to 80° with respect to the table, said point facets extending at an angle of 36° to 41° with respect to the table.

5. Stone according to claim 1, characterised in that it comprises several aforementioned point facets disposed in a cross, in a bow or in a polygonal shape around the pointed culet.

6. Stone according to claim 5, characterised in that the point facets are disposed symmetrically with respect to the pointed culet.

7. Stone according to claim 5, characterised in that the point facets are disposed asymmetrically with respect to the pointed culet.

8. Stone cutting method comprising a faceting of a crown having at its centre a planar table surrounded by crown facets, a faceting of a pavilion having a pointed culet and several pavilion facets and formation of a girdle between the crown and the pavilion, characterised in that it comprises a cutting of at least one pavilion facet in the form of a point facet that extends from the pointed culet to an intermediate location between the girdle and the culet.

9. Method according to claim 8, characterised in that it comprises a cutting of a point facet which, with respect to the said culet, is situated opposite each aforementioned point facet.

10. Method according to claim 8. characterised in that the cutting of each point facet is carried out at an angle of 25° to 52° with respect to the table.

11. Method according to claim 10, characterised in that the faceting of the crown comprises a formation of crown facets at an angle of 25° to 80° with respect to the table and in that the cutting of each point facet is carried out at an angle of 36° to 41° with respect to the table.
